(19) United States
(12) Patent Application Publication
(10) Pub. No.: US 2026/0367587 A1
(43) Pub. Date: Nov. 19, 2026

(54) METHOD FOR DETECTING AND CHARACTERIZING, BY ARTIFICIAL INTELLIGENCE, DEFECTS ON A MICROGRAPH OF AN OBJECT

(71) Applicant: Brembo S.p.A., Curno, Bergamo (IT)

(72) Inventors: Danilo BENETTI, Curno, Bergamo (IT); Luciano BERBOTTO, Curno, Bergamo (IT); Fabio DAMIANI, Curno, Bergamo (IT); Mahshad KHORNEGAH, Curno, Bergamo (IT); Micael RESCATI, Curno, Bergamo (IT)

(21) Appl. No.: 19/141,220

(22) PCT Filed: Dec. 20, 2023
(86) PCT No.: PCT/IB2023/062997

§ 371 Date: Jun. 19, 2025

(30) Foreign Application Priority Data
Dec. 21, 2022 (IT) 102022000026196

(51) Int. Cl. G05B 13/02

(52) U.S. Cl. CPC G05B 13/0265

(57) ABSTRACT

A method for identifying and characterizing surface defects on an object by means of electronic processing is described. Such a method comprises the steps of acquiring at least one micrograph or digital image, from a microscope, of the object or a part of the object on which the defects are to be identified; then, providing the aforesaid at least one acquired micrograph or digital image to an algorithm trained by means of artificial intelligence and/or machine learning techniques; then, recognizing the defects and identifying them by means of a first mask, by the trained algorithm, and providing, as the output of the trained algorithm, a first processed image in which the recognized defects are identified by the aforesaid first mask. The method further provides processing the aforesaid first processed digital image by means of filtering and morphological closing operations, to highlight the edges of the defects in a cleaner and clearer manner, by means of a segmentation operation adapted to visually highlight the individual defects identified in the image, thus obtaining a second processed image and a second processed mask adapted to identify the defects and to highlight and characterize the contours and shape of the defects in an improved manner. The method further comprises the step of applying Computer Vision techniques/algorithms to the aforesaid second processed image, to determine characterizing information of each of the detected defects. Such characterizing information comprise, for each of the identified defects, at least the following information: defect category, position of the defect with respect to a reference coordinate system associated with the image, at least one geometric/dimensional parameter of each defect. The aforesaid at least one trained algorithm is trained in a preliminary training step carried out on training digital images, each of the training digital images being labeled, by means of labeling of known defects, and filtered to produce a mask corresponding as closely as possible to the labeled defects. A system for detecting and characterizing defects on a micrograph of an object, capable of performing the aforesaid method, is also described.

### TECHNOLOGICAL BACKGROUND OF THE INVENTION

### Field of Application

The present invention relates to a method for detecting and characterizing defects on a micrograph of an object, using artificial intelligence (Al) and electronic processing.

### Description of the Prior Art

The use of artificial intelligence (AI) and Computer Vision (CV) techniques for detecting photographically reproduced defects and the quantification thereof in dimensional terms is now well-established. Such known techniques and tools include the analysis, by a suitably conceived algorithm (usually, one or more neural networks), of images acquired manually or automatically (partially or totally) in which defects could be present.

Among the types of images to which it is possible to apply this type of known techniques there are micrographic images of general materials (for example, metals and/or crystals).

Micrographs allow observing the microscopic structure of a material. This is interesting and useful for several purposes including, for example, quality checks on the internal matrix of a product. In fact, the macroscopic mechanical properties of the alloys largely depend on the microstructure.

In the case of components with safety functions, such as, for example, brake calipers, meeting the mechanical resistance requirements is even more critical.

The ability to promptly identify, classify and measure defects in the microstructure of a product can be essential for providing feedback on production, thus avoiding economic losses and improving production efficiency. Moreover, the systematic collection of information relating to defects is a prerequisite for improving manufacturing processes and design guidelines.

However, the methods proposed in the prior art to exploit the potential of Artificial Intelligence and Computer Vision for detecting defects on micrographs have several significant limitations and drawbacks.

First of all, during the training step, the tagging procedure, usually adopted, includes drawing a rectangle around each observable defect, and does not take into account the shape of the defects themselves which is usually irregular. The tagging thus performed according to known techniques considerably limits the performance of the artificial intelligence algorithm.

Moreover, in the prior art, in order to recognize which pixels of the digital image considered belong to a defect, the segmentation operation is applied to the output of the suitably trained neural network. Since the mask produced by the neural network does not typically perfectly coincide with the defect, the result of the segmentation is negatively affected.

In addition, in the prior art, neural networks are applied to individual images. However, the analysis must be typically carried out on an entire sample.

If the sample to be analyzed is larger than the field of view of the microscope which acquires the individual images or micrographs, such a sample is scanned as follows: an image acquisition system implemented in the microscope moves the sample, acquiring images of each portion thereof, until it covers the entire surface thereof.

Since the images acquired for the entire sample are conventionally several (for example, of the order of hundreds of digital images in the case of a section of a brake caliper), it is not feasible in the prior art to apply one or more neural networks to the combined image of the individual images (for example, due to the known limitations of the number of pixels processable by the neural networks described in the literature). Combined image means the image obtained by juxtaposing the individual acquired images, based on the order of acquisition thereof, belonging to a single sample, against one another horizontally and vertically in the plane, without leaving spaces or creating overlaps.

Knowing the position of defects in the reference system of the sample (therefore referring to the entire sample) is very important in the metallurgical field, since the presence of the same defect in different positions of the product affects the mechanical properties thereof in a different manner.

Based on the above description, the need is apparent to devise methods for detecting and characterizing defects, on a micrograph of an object, by means of an appropriate combined use of artificial intelligence (AI) and Computer Vision (CV), which are improved compared to the known solutions mentioned above, and therefore such as to meet the technical needs described above, which are not fully met by the prior art.

### SUMMARY OF THE INVENTION

It is an object of the present invention to provide a method for detecting and characterizing, by electronic processing, defects on a micrograph of an object, such as to allow at least partially obviating the drawbacks mentioned above with reference to the prior art, and responding to the aforementioned needs particularly felt in the technical field considered.

Such an object is achieved by a method according to claim 1.

Further embodiments of such a method are defined in claims 2-24.

It is a further object of the invention to provide a system for detecting and characterizing defects on a micrograph of an object, capable of performing the aforesaid method. Such an object is achieved by a system according to claim 25.

Further embodiments of such a system are defined in claims 26-30.

### BRIEF DESCRIPTION OF THE DRAWINGS

Further features and advantages of the method and system according to the invention will be apparent from the following description of preferred embodiments, given by way of non-limiting indication, with reference to the accompanying drawings, in which:

FIG. 1 shows a digital image processed according to a step of an embodiment of the method, and specifically, in the upper part of the Figure, an image on which a first tagging operation was carried out and, in the lower part of the Figure, the image further processed by applying the Otsu filter;

FIG. 2 shows two examples of defect categories recognizable by a trained algorithm comprised in an embodiment of the method according to the invention;

FIG. 3 shows, in the upper part, a micrograph (digital image) acquired by a microscope, and, in the lower part, a respective digital image processed, according to a step of the method of the invention, by applying a Deep Learning algorithm and a segmentation operation;

FIG. 4 shows a digital image which is further processed, according to a step of the method of the invention, in which dimensional parameters calculated on individual defects and clusters of defects are graphically represented;

FIGS. 5-8 show respective examples of a graphical user interface (GUI), and the related functions, made available by an embodiment of the method according to the present invention; in particular, FIG. 5 shows an example of a GUI in which the user can select the image/s to be processed; FIG. 6 shows an example of a GUI in which the user can view, on each image, the masks processed by the algorithm; FIG. 7 shows an example of a GUI in which the user can view, for each defect, the position information in the reference system of the image and the relative dimensional information; FIG. 8 shows an example of a GUI in which the user can manually define, for each defect, a region about the defect and relaunch the Computer Vision algorithm if the previous result is deemed unsatisfactory;

FIG. 9 shows an example micrographic analysis report generated by the method, according to an embodiment;

FIG. 10 shows a simplified block diagram of a system adapted to perform the aforesaid method, according to an embodiment of the invention;

FIG. 11 shows a simplified block diagram of another embodiment of the system according to the invention, capable of performing the method according to the invention in another manner.

### DETAILED DESCRIPTION

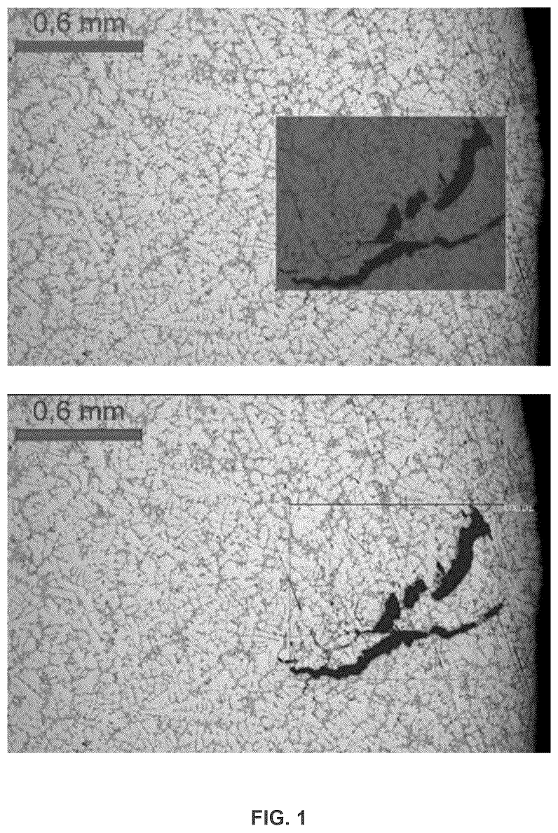

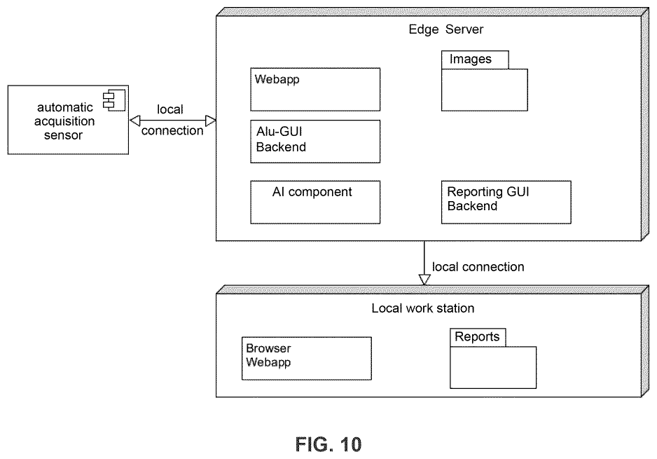

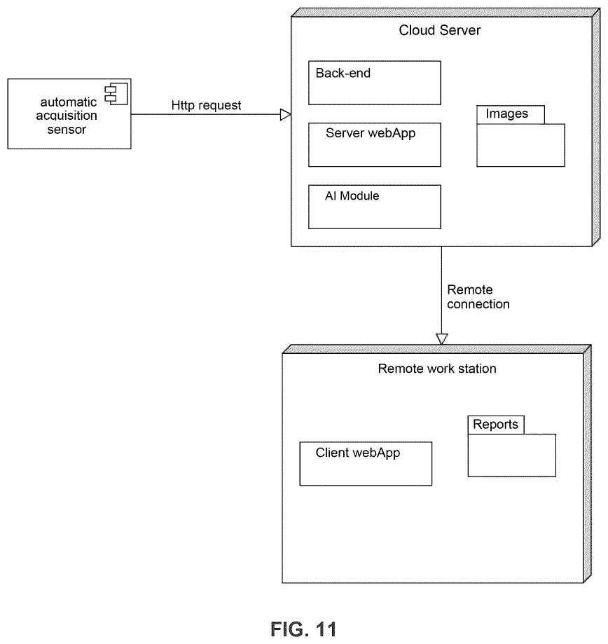

With reference to FIGS. 1-11, there is described a method for identifying and characterizing surface defects on an object by means of electronic processing.

Such a method comprises the steps of acquiring at least one micrograph, or at least one digital image from a microscope, of the object or a part of the object on which the defects are to be identified; then, providing the aforesaid at least one acquired micrograph or digital image to an algorithm trained by means of artificial intelligence and/or machine learning techniques; then, recognizing the defects and identifying them by means of a first mask, by the trained algorithm, and providing, as the output of the trained algorithm, a first processed image in which the recognized defects are identified by the aforesaid first mask.

The method further provides processing the aforesaid first processed digital image by means of filtering and morphological closing operations, to highlight the edges of the defects in a cleaner and clearer manner, by means of a segmentation operation adapted to visually highlight the individual defects identified in the image, thus obtaining a second processed image and a second processed mask adapted to identify the defects and to highlight and characterize the contours and shape of the defects in an improved manner.

The method further comprises the step of applying Computer Vision techniques/algorithms to the aforesaid second processed image, to determine characterizing information of each of the detected defects.

Such characterizing information comprise, for each of the identified defects, at least the following information: defect category, position of the defect with respect to a reference coordinate system associated with the image, at least one geometric/dimensional parameter of each defect.

The aforesaid at least one trained algorithm is trained in a preliminary training step, based on a training dataset, carried out on training digital images, each of the training digital images being labeled, by means of labeling of known defects, and filtered to produce a mask corresponding as closely as possible to the labeled defects.

In accordance with an embodiment, each of the training digital images is filtered by applying an Otsu filter.

The Otsu filter is a per se known digital image processing technique (see, for example, the article Wuli Wang et al. “Fast Image Segmentation Using Two-Dimensional Otsu Based on Estimation of Distribution Algorithm”—Journal of Electrical and Computer Engineering, Vol. 2017, Volume 2017, Article ID 1735176, https://doi.org/10.1155/2017/1735176).

According to an embodiment of the method, the aforesaid processing step by means of morphological closing operations comprises carrying out image processing operations by means of dilatation and erosion.

The aforesaid “morphological closing” operations, and in particular the “dilatation” and “erosion” operations, are per se known in the field of digital image processing/recognition.

For example, the closing operation is carried out using a part of “erosion” (i.e., removal of “scattered” points of black pixels) and a part of “dilation” (to compensate for the erosion done in the first instance). By virtue of this, a “cleaner” mask is obtained which is freer of isolated points (which, thus, do not negatively influence the measurement of the defects), and, above all, a more precise division of the defects between the various spots is obtained (avoiding the creation of “bridges”).

In accordance with an embodiment of the method, the aforesaid trained algorithm, used to recognize the defects and identify them by means of a first mask, comprises a Deep Learning algorithm/model.

According to an implementation option, the aforesaid trained algorithm, used to recognize the defects and identify them by means of a first mask, comprises a Mask-RCNN algorithm/model, based on neural networks, trained based on an open-source COCO training set.

According to an embodiment of the method, the aforesaid preliminary training step operates starting from a pre-trained algorithm based on a pre-training dataset other than said training dataset, applying transfer learning techniques, in order to achieve the trained algorithm.

In this case, the transfer learning (TL) method is used to build the machine learning (ML) algorithm, i.e., an algorithm pre-trained on another dataset was chosen. Transfer learning is a technique which, in the context of machine learning, includes applying, to solve a problem, the knowledge acquired during the resolution of a similar problem. The re-use or transfer of information from previously learned tasks for learning new tasks has the potential to significantly improve the recognition performance of a machine learning algorithm (in particular, Deep Learning algorithm).

In accordance with an embodiment, the method applies to at least one object comprising a metallurgical/metal object.

According to another embodiment, the method is applied to at least one object comprising an object made of ceramic materials in industrial, geological or mineralogical samples.

According to another embodiment, the method is applied to a brake caliper for a vehicle braking system.

In accordance with different possible embodiments, the aforesaid defects, detectable by means of the method, comprise the presence of one or more of the following defects: oxide, and/or shrinkage cavities and/or gas bubbles, and/or inclusions and/or cracks and/or junction points and/or cleaning defects of the sample.

According to an embodiment of the method, the aforesaid at least one geometric/dimensional parameter determinable for each identified defect comprises the total area of the defect.

In accordance with another embodiment of the method, the aforesaid step of determining characterizing information of each of the detected defects comprises identifying, on the second processed image, all the pixels belonging to the detected defect considered and determining a minimum area rectangle containing all the pixels belonging to the detected defect considered, and determining the maximum length of the longest side of such a minimum area rectangle.

In such a case, the aforesaid at least one geometric/dimensional parameter determinable for each identified defect thus comprises the maximum length of the longest side of such a minimum area rectangle.

In accordance with another embodiment of the method, the aforesaid step of determining characterizing information of each of the detected defects comprises identifying, on the second processed image, all the pixels of an extended group or cluster of adjacent defects and determining a minimum area rectangle containing all the pixels belonging to the extended group or cluster of adjacent defects considered, and determining the maximum length of the longest side of such a minimum area rectangle.

In such a case, the aforesaid at least one geometric/dimensional parameter determinable for each identified defect thus comprises the maximum length of the longest side of such a minimum area rectangle.

In accordance with an embodiment, the method is applied to a plurality of micrographs or digital images of a sample of the object, to analyze the entire sample even when the entire sample is larger than the field of view of the microscope from which said micrographs or digital images derive.

Therefore, in such a case, the aforesaid acquisition step comprises the sequential acquisition from the sample of the object of the micrographs or digital images of the aforesaid plurality.

According to an implementation option of such an embodiment, the method includes carrying out the aforesaid step of recognizing and identifying the defects, by the trained algorithm, on each micrograph or digital image of the plurality of micrographs or digital images, and providing a plurality of respective first processed images.

The method further includes juxtaposing the aforesaid first processed images horizontally and vertically in a plane, so as to obtain an extended visual planar reconstruction image without leaving spaces or creating overlaps.

In such a case, the method finally includes carrying out the step of processing the first processed digital image on the extended visual planar reconstruction image, to obtain a second extended processed image; and to carry out the aforesaid step of applying Computer Vision techniques/algorithms, to determine characterizing information of each of the defects detected, on the aforesaid second extended processed image.

According to a particular implementation option, the aforesaid extended visual planar reconstruction image is an overall image of the object sample, and the aforesaid second extended processed image is a second overall processed image of the object sample.

In accordance with another implementation option, the method comprises providing an extended digital image by juxtaposing the acquired micrographs or digital images of the sample and providing both the extended digital image and each of the individual acquired micrographs or digital images, which represent individual parts of the extended digital image, to a first trained neural network, in addition to and other than the aforesaid trained algorithm, in a preliminary training step, in order to select a subset of individual digital images or micrographs, among the acquired digital images or micrographs, based on criteria related to the presence and/or importance and/or easy detectability of defects.

The method further provides carrying out the aforesaid steps of recognizing the defects and identifying them, and providing a respective first processed image, by the aforesaid trained algorithm (in this case, consisting of a second neural network), on each digital image of the aforesaid selected subset of digital images.

In such a case, the method finally includes carrying out the processing step by means of filtering and morphological closing operations on each of the first processed images, to obtain a plurality of respective second processed images; and to carry out the step of applying Computer Vision techniques/algorithms to each of the second processed images to determine information characterizing each of the defects detected.

According to a particular implementation option, the aforesaid criteria for selecting the digital images to be analyzed comprise:
selecting the digital images with the greatest number of defects, and/or
selecting the digital images comprising one or more types of defects predetermined as relevant, and/or
selecting the digital images from specific areas of the sample and predetermined as relevant with the greatest number of defects, for example close to the edges.

In accordance with an embodiment, the method further comprises the step of providing an operator with a computerized graphical user interface, and allowing the operator, by means of such a graphical user interface, to perform one or more of the following actions:
selecting the micrograph or digital image, or micrographs or digital images, to be processed and analyzed, among the acquired micrographs or digital images of the object sample; and/or
displaying, on each selected micrograph or digital image, the masks processed by the trained algorithm and/or the first processed digital images and/or the second processed digital images; and/or
displaying, for each identified defect, the category of the defect, and/or the position of the defect with respect to a reference coordinate system associated with the digital image, and/or said at least one geometric/dimensional parameter of the defect; and/or
manually defining, in the digital image, a region around the defect considered if the result is unsatisfactory, and re-launching the execution of the method steps.

According to an embodiment of the method, all identified defects and all determined information about each defect are aggregated in an electronic report, accessible by a computer.

According to an implementation option of such an embodiment, the electronic report comprises information on the exceeding of thresholds related to the maximum number of defects, the maximum number of a certain class of defects, the maximum size of a defect or a cluster of defects.

In accordance with an embodiment, the method is performed by local electronic processing means in communication with digital image or micrograph acquisition means.

In accordance with another embodiment of the method, the acquired digital images to be processed are saved in the cloud, and/or the aforesaid first processed images and second processed images are saved in the cloud, so as to be accessible by web applications.

In accordance with another embodiment of the method, the aforesaid steps of recognizing the defects and identifying them, processing the first processed digital images by means of filtering and closing operations, applying Computer Vision techniques/algorithms to the second processed images are partially or entirely carried out in a distributed manner, using resources made available by an electronic processing architecture of the cloud type.

According to an embodiment, the mechanism provided in the method for classifying defects based on the impact thereof on the correct functioning of the product and on the safety thereof includes dividing a priori the component into non-overlapping areas. For each area, some constraints are set to be respected, such as, for example: maximum number of defects, maximum length of each defect, and so on.

Again with reference to FIGS. 1-11, a system for detecting and characterizing defects on a micrograph of an object is described.

Such a system comprises digital image acquisition means, configured to acquire at least one micrograph, or at least one digital image from a microscope, of the object or a part of the object on which the defects are to be identified, and also electronic processing means, configured to receive the aforesaid at least one acquired digital image and to recognize defects and identify them by means of a first mask, using at least one algorithm trained by means of artificial intelligence and/or machine learning techniques, operating in electronic processing means.

The at least one trained algorithm was trained in a preliminary training step based on a training set carried out on training digital images, in which each of the training digital images was labeled, by means of labeling of known defects, and filtered to produce a mask corresponding as closely as possible to the labeled defects.

The aforesaid electronic processing means are further configured to:
provide as the output of the trained algorithm a first processed image, in which the recognized defects are identified by the aforesaid first mask;
process the aforesaid first processed digital image by means of filtering and closing operations, to highlight the edges of the defects in a cleaner and clearer manner, and by means of a segmentation operation adapted to visually highlight the individual defects identified in the image, thus obtaining a second processed image and a second processed mask adapted to identify the defects and to highlight and characterize the contours and shape of the defects in an improved manner;
apply Computer Vision techniques/algorithms to such a second processed image to determine characterizing information of each of the detected defects, in which said characterizing information comprise, for each of the identified defects, at least the following: defect category, position of the defect with respect to a reference coordinate system associated with the image, at least one geometric/dimensional parameter of each defect.

According to an embodiment of the system, the electronic processing means are configured to provide a user/operator with a graphical user interface, configured to allow the user/operator to perform one or more of the following actions:
selecting the micrograph or digital image, or micrographs or digital images, to be processed and analyzed, among the acquired micrographs or digital images of the object sample; and/or
displaying, on each selected micrograph or digital image, the masks processed by the trained algorithm and/or the first processed digital images and/or the second processed digital images; and/or
displaying, for each identified defect, the category of the defect, and/or the position of the defect with respect to a reference coordinate system associated with the digital image, and/or said at least one geometric/dimensional parameter of the defect; and/or
manually defining, in the digital image, a region around the defect considered if the result is unsatisfactory, and re-launching the execution of the method steps.

According to an embodiment of the system, the aforesaid micrograph or digital image acquisition means comprises an electron microscope.

According to an embodiment of the system, the aforesaid electronic processing means comprise a local electronic processor, or edge device, operatively connected to the acquisition means.

According to another embodiment of the system, the aforesaid electronic processing means comprise a user device, a remote server and a remote computer, connected to one another in the cloud, and operatively connected through the web to the digital image acquisition means and the user device capable of providing the graphical user interface.

In accordance with several possible embodiments, the system is configured to carry out a method according to any one of the embodiments of the method described above.

Further details of the method will be given below, referring to FIGS. 1-11, for illustrative and non-limiting purposes only, according to an embodiment of the invention.

An image acquisition system implemented in a microscope is capable of acquiring digital images of the sample of the object to be analyzed, suitably prepared for analysis and placed in the observation area. The digital images thus acquired represent the input for the machine learning (ML) model or algorithm capable of identifying the possible presence of defects thereon.

It will be indicated below how this embodiment of the method carries out the steps conventionally provided for the development of a Machine Learning algorithm; input preparation, tagging and model training.

The input preparation step is avoided, in this method, since the adopted algorithm takes the digital images directly acquired by the microscope as input. This is advantageous from the point of view of the computational load and therefore also of time saving.

As for the “labelling” activity, commonly defined by the term “tagging”, it comprises:
manual labeling of the defects depicted in the images produced by the microscope, for example by tracing the smallest rectangle that contains the entire defect (“weak labeling” or “weak tagging”);
application of an Otsu filter to the digital image tagged as indicated above, so as to produce a mask overlapping as much as possible the defect tagged in the image.

An example of a weakly tagged image before and after applying the Otsu filter is shown in FIG. 1.

Accurate tagging (as shown above, implemented by this embodiment of the method) is an essential requirement to obtain a well-functioning Deep Learning algorithm, ensuring that the tagged pixels exclusively correspond to positions where defects are present, thus improving the performance of the model.

The tagging step is followed by a training process: a subset of the training dataset, with tagged training images—consisting of, for example, at least 100 images for each type of defect to be identified—is provided as input to the artificial intelligence/machine learning algorithm to calibrate the model parameters and make it suitable for making predictions.

According to a particular implementation option, the aforesaid subset of the tagged training dataset is enriched by data augmentation techniques.

In this embodiment, a transfer learning process was used to build the machine learning algorithm, i.e., an algorithm pre-trained on another dataset was chosen. In the example shown herein, the Mask-RCNN model, based on neural networks, was chosen from among those available (see, for example, “Mask R-CNN”—Kaiming He, Georgia Gkioxari, Piotr Dollár & Ross Girshick, 2018—https://arxiv.org/abs/1703—an actually implemented version is https://github.com/matterport/Mask_RCNN), trained on the open source COCO dataset (for example, in the version https://cocodataset.org/#home).

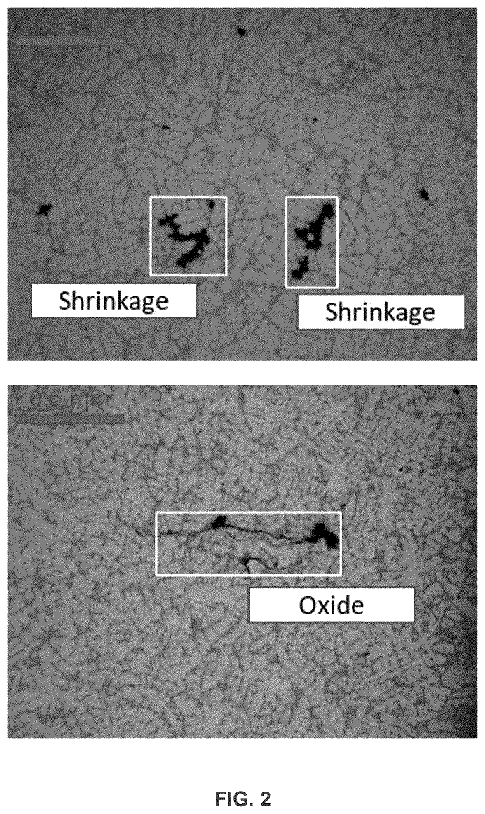

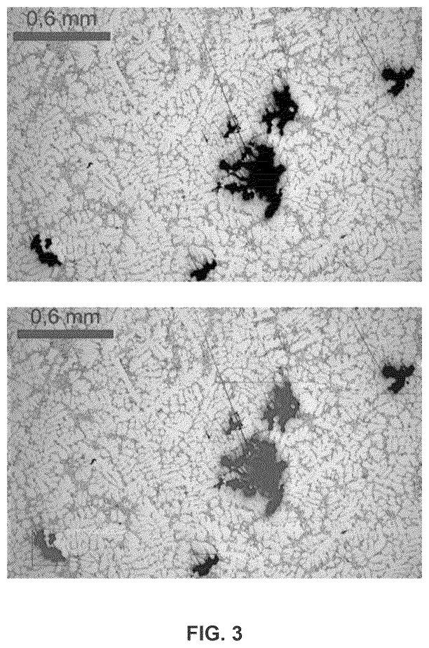

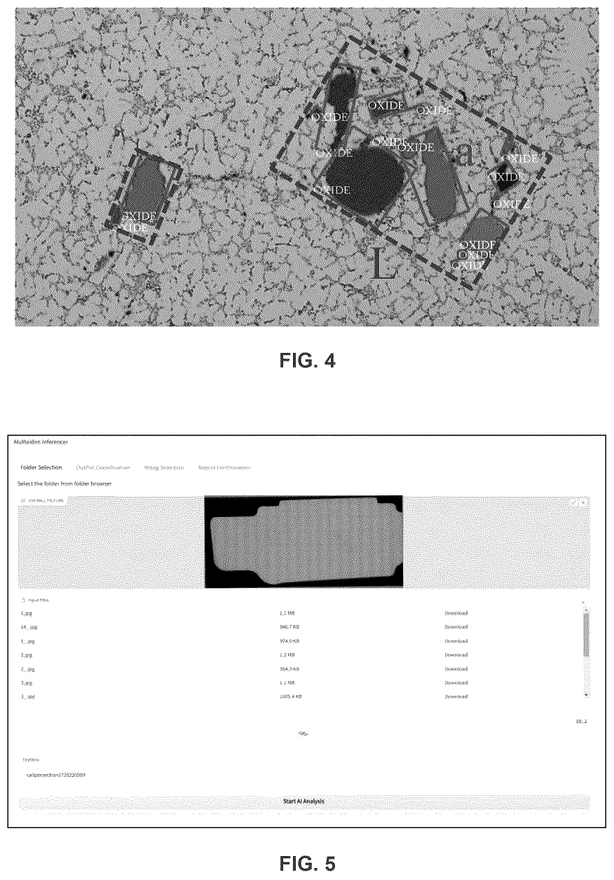

The identification of the defect and the extraction of some information thereof comprise the following steps.
(i). Applying the trained algorithm according to the procedure described above to each image acquired by the microscope to identify and classify any possible present defect. The classes of recognized defects include for example: oxide, shrinkage cavities, gas bubbles, inclusions, cracks-see FIG. 2, in which a shrinkage cavity defect (“shrinkage” in the figure) and a defect due to the presence of oxide (“oxide” in the figure) are shown.
(ii) Applying, at the output of the neural network, a Computer Vision (CV) pipeline comprising: a filter of the OTSU type, dilatation and erosion, so as to clean and fit the edges precisely.
(iii) Applying a segmentation operation to the image processed as described in step (ii) above, so as to visually highlight the individual defects present in the image (see FIG. 3).
(iv) For each defect, extracting from the image and saving some information, comprising, in this example:
   a. Defect category;
   b. Position in the reference system of the image; using classic Computer Vision techniques, the following parameters are also calculated, first in units of number of pixels, then converted into metric units of measurement with standard methodologies (see for example FIG. 4):
   c. Total area;
   d. a, i.e., the maximum length of the longest edge of the rectangle of minimum area containing all the pixels of the extended defect;
   e. L, i.e., the maximum length of the longest edge of the rectangle of minimum area containing all the pixels of the extended cluster of defects. A cluster is defined as a group of defects such that each defect i of length ai has at least one other defect j of length aj at a distance d such that: d<(ai+aj)/2.

In mechanical components which are subject to thermal cycles during service life, such as, for example, brake calipers, clusters are important for evaluating the mechanical properties of the material and therefore of the product.

As the temperature increases during use, spatially close defects coalesce, creating a discontinuity in the matrix of the material of larger size than that of the individual starting defects. The presence of clusters therefore indicates a worsening factor in the mechanical properties of the material.

In this embodiment, the choice of applying, downstream of the object recognition algorithm (object detection—step (i)), Computer Vision CV operations (step (ii)) and segmentation operations (step (iii)) is due to the fact that the “object detection” algorithms of the prior art mostly return rectangular bounding boxes, which are not sufficient to calculate the above-mentioned dimensional parameters for each defect. In fact, bounding boxes tend to unite nearby defects in a more or less arbitrary manner.

Moreover, the semantic segmentation algorithms of the prior art are not capable of returning masks sufficiently precise for calculating the area of the defect and often combine the defective areas in an arbitrary manner. To correct this behavior and improve the quality of the generated masks, the aforesaid step (ii) is applied, which is thus an improvement.

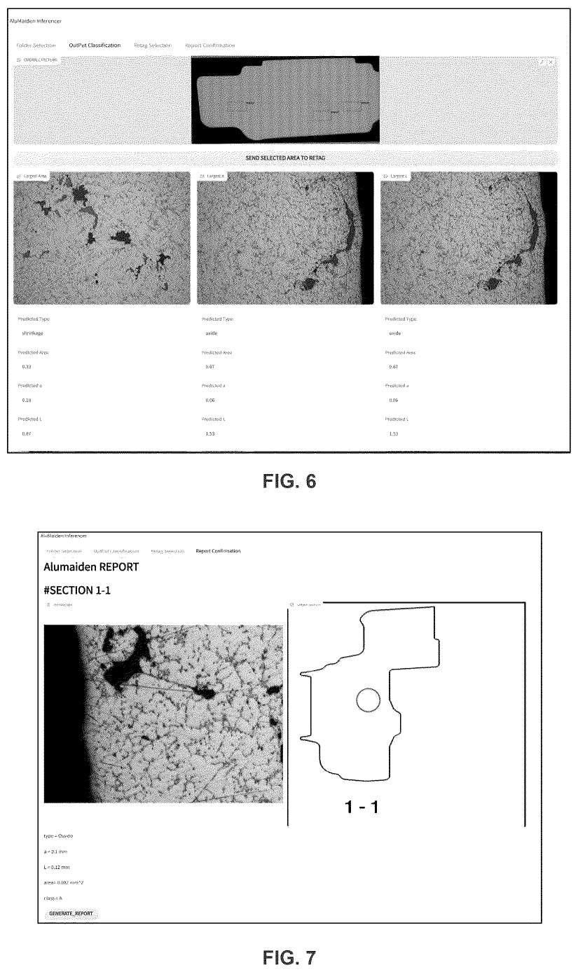

According to an embodiment, the operator has a graphical user interface available, by means of which it is possible to:
select the image/s to be processed (see for example FIG. 5);
view the masks processed by the algorithm on each image (see for example FIG. 6);
display, for each defect, position information in the image reference system and at least the dimensional information mentioned above (see for example FIG. 7);
for each defect, if the result is considered unsatisfactory, manually define a region about the defect and relaunch the algorithm (see for example FIG. 8).

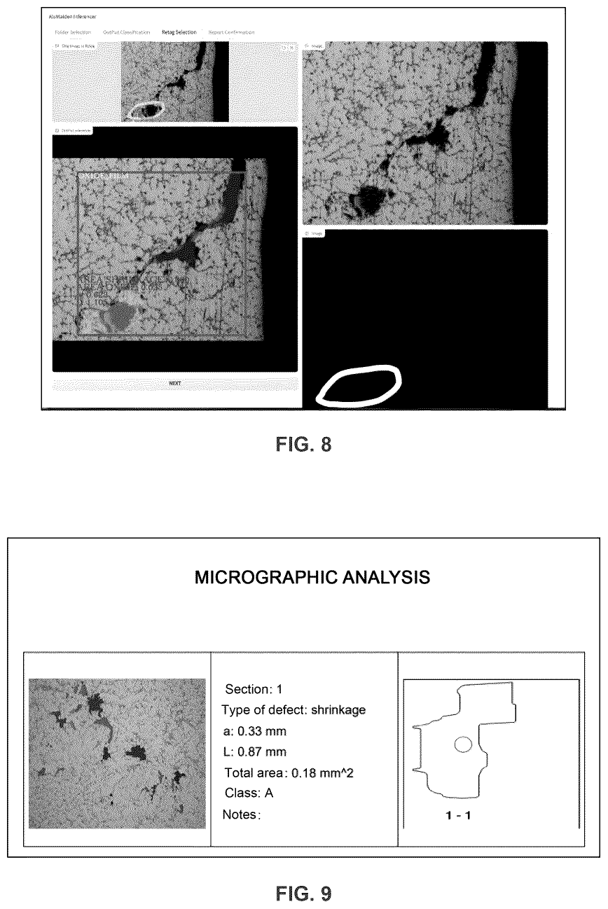

In this implementation example, the information collected on one or more analyzed images is finally advantageously aggregated in a report (see e.g., FIG. 9).

The method described so far is applicable to any micrographic image appropriately acquired with a microscope. However, usually, the search for defects is conducted on an entire sample. If the sample to be analyzed is larger than the field of view of the microscope, it is possible to apply the method described to the entire sample in two manners, i.e., according to two implementation options, hereinafter briefly indicated as “bottom-up approach” and “top-down approach”.

### A. “Bottom-Up” Approach

The described algorithm is applied individually to each of the acquired images. The images output by the algorithm are juxtaposed against one another horizontally and vertically in the plane, without leaving spaces or creating overlaps.

### B. “Top-Down” Approach

This second approach includes training a neural network to select a chosen number of individual images on the combined image, and applying the algorithm individually to that selection. The selected individual images can correspond, for example, to the images with the greatest number of defects or with defects of a certain type, or can be images from a specific area of the sample, for example close to the edges. It is also possible for the operator to manually choose, by means of the graphical user interface, to which regions of the sample the algorithm is to be applied.

This second method is advantageous in terms of computational time, since it is limited to examining a subset of the images forming the sample, i.e., those selected as the most significant.

Since, regardless of the approach followed, the computer on which the algorithm is implemented stores, for each individual image, the position information in the reference system of the sample, the information on the defects contained therein is mapped into the reference system of the sample.

According to an implementation option, such information can thus be displayed in the sample reference system by means of the graphical user interface.

Moreover, for each identified defect, it is possible to deduce how far the defect is from the external surface of the product. Such information is also communicated to the operator by means of the graphical user interface.

According to an implementation option, the information on the defects identified by means of the analysis of an individual image or on multiple images belonging to the same sample is aggregated, respectively, at the image and sample level.

According to an implementation option, quality constraints are established for the sample which, if not respected, trigger the sending of a notification to the operator by means of a graphical user interface.

Examples of such constraints include, for example, (but are not limited to) maximum number of defects, maximum number of a certain class of defects, maximum size of a defect or cluster of defects, and so on.

According to an embodiment, in the context of a “top-down” architecture, the recognition of the most defective areas is carried out using a Computer Vision algorithm (and not, in this case, one or more neural networks). This embodiment has the advantage of saving time for training the Deep Learning algorithm, given a greater resilience of the algorithm. For example, if an image with a zoom different from that of the images used for training were provided as input to a Deep Learning algorithm, this would decrease the performance of the Deep Learning algorithm. Instead, by analyzing the image with a zoom different from that of the images used for training using Computer Vision techniques, the performance would in principle remain unchanged.

As it can be seen, the objects of the present invention as previously indicated are fully achieved by the method described above by virtue of the features shown above in detail. The advantages and technical issues solved by the method according to the invention have already been mentioned above, with reference to the various features and aspects of the method.

Those skilled in the art may make changes and adaptations to the embodiments of the methods described above or can replace elements with others which are functionally equivalent in order to meet contingent needs without departing from the of the following claims. Each of the features described above as belonging to a possible embodiment can be implemented irrespective of the other embodiments described.

1-30. (canceled)

31. A method for detecting and characterizing defects on a micrograph of an object, by means of electronic processing, comprising the steps of:
acquiring at least one micrograph, or at least one digital image from a microscope, of the object or a part of the object on which the defects are to be identified;
providing said at least one acquired micrograph or digital image to at least one algorithm trained by means of artificial intelligence and/or machine learning techniques, wherein the at least one trained algorithm is trained in a preliminary training step based on a training set carried out on training digital images, each of the training digital images being labeled, by means of labeling of known defects, and filtered to produce a mask corresponding as closely as possible to the labeled defects;
recognizing the defects and identifying them by means of a first mask, by the trained algorithm, and providing, as the output of the trained algorithm, a first processed image in which the recognized defects are identified by said first mask;
processing said first processed digital image by means of filtering and morphological closing operations, to highlight the edges of the defects in a cleaner and clearer manner, and a segmentation operation adapted to visually highlight the individual defects identified in the image, thus obtaining a second processed image and a second processed mask adapted to identify the defects and to highlight and characterize the contours and shape of the defects in an improved manner;
applying Computer Vision techniques/algorithms to said second processed image, to determine characterizing information of each of the detected defects, wherein said characterizing information comprise, for each of the identified defects, at least the following:
defect category,
position of the defect with respect to a reference coordinate system associated with the image,
at least one geometric/dimensional parameter of each defect.

32. A method according to claim 31, wherein each of the training digital images is filtered by applying an Otsu filter.

33. A method according to claim 31, wherein said processing step by means of morphological closing operations comprises carrying out image processing operations by means of dilatation and erosion.

34. A method according to claim 31, wherein said preliminary training step, in order to achieve the trained algorithm, operates starting from a pre-trained algorithm based on a pre-training dataset other than said training dataset, applying transfer learning techniques,
and/or wherein said trained algorithm, used to recognize the defects and identify them by means of a first mask, comprises a Deep Learning algorithm/model.

35. A method according to claim 31, wherein said trained algorithm, used to recognize the defects and identify them by means of a first mask, comprises a Mask-RCNN algorithm/model, based on neural networks, trained based on an open-source COCO training set.

36. A method according to claim 31, wherein said object, to which the method is applied, comprises a metallurgical/metal object, or an object made of ceramic materials in industrial, geological or mineralogical samples.

37. A method according to claim 31, wherein said object, to which the method is applied, comprises a brake caliper for a vehicle braking system.

38. A method according to claim 31, wherein said defects, detectable by means of the method, comprise the presence of one or more of the following defects: oxide, and/or shrinkage cavities and/or gas bubbles, and/or inclusions and/or cracks and/or junction points and/or cleaning defects of the sample.

39. A method according to claim 31, wherein said at least one geometric/dimensional parameter determinable for each identified defect comprises the total area of the defect.

40. A method according to claim 31, wherein said step of determining characterizing information of each of the detected defects comprises identifying, on the second processed image, all the pixels belonging to the detected defect considered and determining a minimum area rectangle containing all the pixels belonging to the detected defect considered, and determining the maximum length of the longest side of said minimum area rectangle,
wherein said at least one geometric/dimensional parameter determinable for each identified defect thus comprises the maximum length of the longest side of said minimum area rectangle.

41. A method according to claim 31, wherein said step of determining characterizing information of each of the detected defects comprises identifying, on the second processed image, all the pixels of an extended group or cluster of adjacent defects and determining a minimum area rectangle containing all the pixels belonging to the extended group or cluster of adjacent defects considered, and determining the maximum length of the longest side of said minimum area rectangle,
wherein said at least one geometric/dimensional parameter determinable for each identified defect thus comprises the maximum length of the longest side of said minimum area rectangle.

42. A method according to claim 31, wherein the method is applied to a plurality of micrographs or digital images of an object sample, to analyze the entire sample even when said entire sample is more extended than the field of view of the microscope from which said micrographs or digital images derive, and wherein said acquiring step thus comprises the sequential acquisition of the micrographs or digital images of said plurality from the object sample.

43. A method according to claim 42 comprising:
carrying out said step of recognizing and identifying the defects, by the trained algorithm, on each micrograph or digital image of said plurality of micrographs or digital images, and providing a plurality of respective first processed images;
juxtaposing said first processed images horizontally and vertically in a plane, so as to obtain an extended visual planar reconstruction image without leaving spaces or creating overlaps;
carrying out said step of processing the first processed digital image on the extended visual planar reconstruction image to obtain a second extended processed image;
carrying out said step of applying Computer Vision techniques/algorithms, to determine characterizing information of each of the detected defects, to said second extended processed image,
wherein said extended visual planar reconstruction image is an overall image of the object sample, and wherein said second extended processed image is a second overall processed image of the object sample.

44. A method according to claim 42 comprising:
providing an extended digital image by juxtaposing the acquired micrographs or digital images of the sample;
providing both said extended digital image and each of said acquired micrographs or digital images, which represent individual parts of said extended digital image, to a first trained neural network, in addition to and other than said trained algorithm, in a preliminary training step, in order to select a subset of individual digital images or micrographs, among the acquired digital images or micrographs, based on criteria related to the presence and/or importance and/or easy detectability of defects;
carrying out said steps of recognizing the defects and identifying them, and providing a respective first processed image, by said trained algorithm consisting of a second neural network, on each digital image of said selected subset of digital images;
carrying out said processing step through filtering and morphological closing operations on each of said first processed images, to obtain a plurality of respective second processed images;
carrying out said step of applying Computer Vision techniques/algorithms to each of said second processed images to determine characterizing information of each of the detected defects,
wherein said criteria for selecting the digital images to be analyzed comprise:
selecting the digital images with the greatest number of defects, and/or
selecting the digital images comprising one or more types of defects predetermined as relevant, and/or
selecting the digital images from specific areas of the sample and predetermined as relevant with the greatest number of defects, for example close to the edges.

45. A method according to claim 31, further comprising the step of providing an operator with a computerized graphic interface, and allowing the operator, by means of said graphic interface, to perform one or more of the following actions:
selecting the micrograph or digital image, or micrographs or digital images, to be processed and analyzed, among the acquired micrographs or digital images of the object sample; and/or
displaying, on each selected micrograph or digital image, the masks processed by the trained algorithm and/or the first processed digital images and/or the second processed digital images; and/or
displaying, for each identified defect, the category of the defect, and/or the position of the defect with respect to a reference coordinate system associated with the digital image, and/or said at least one geometric/dimensional parameter of the defect; and/or
manually defining, in the digital image, a region around the defect considered if the result is unsatisfactory, and re-launching the execution of the method steps.

46. A method according to claim 31, wherein all identified defects and all determined information about each defect are aggregated in an electronic report, accessible by a computer,
wherein said electronic report comprises information on the exceeding of thresholds related to the maximum number of defects, the maximum number of a certain class of defects, the maximum size of a defect or a cluster of defects,
wherein said criteria of maximum number of defects, and/or maximum number of a certain class of defects, and/or maximum size of a defect or a cluster of defects are determined for each of a set of non-overlapping areas of the object, in which the object under examination is divided a priori, in order to classify the defects according to the impact thereof on the correct functioning and/or safety of the object.

47. A method according to claim 31, performed by local electronic processing means in communication with digital image or micrograph acquisition means,
wherein the acquired digital images to be processed are saved in the cloud, and/or said first processed images and second processed images are saved in the cloud, so as to be accessible by web applications,
and/or wherein said steps of recognizing the defects and identifying them, processing the first processed digital images by means of filtering and closing operations, applying Computer Vision techniques/algorithms to the second processed images are partially or entirely carried out in a distributed manner, using resources made available by an electronic processing architecture of the cloud type.

48. A system for detecting and characterizing defects on a micrograph of an object, comprising:
digital image acquisition means, configured to acquire at least one micrograph, or at least one digital image from a microscope, of the object or a part of the object on which the defects are to be identified;
electronic processing means, configured to receive said at least one acquired digital image and to recognize the defects and identify them by means of a first mask, through at least one algorithm trained by means of artificial intelligence and/or machine learning techniques, operating in the electronic processing means, wherein the at least one trained algorithm has been trained in a preliminary training step based on a training set carried out on training digital images, each of the training digital images being labeled, by means of labeling of known defects, and filtered to produce a mask corresponding as closely as possible to the labeled defects;
wherein the electronic processing means are further configured to:
provide as the output of the trained algorithm a first processed image, in which the recognized defects are identified by said first mask;
process said first processed digital image by means of filtering and closing operations, to highlight the edges of the defects in a cleaner and clearer manner, and a segmentation operation adapted to visually highlight the individual defects identified in the image, thus obtaining a second processed image and a second processed mask adapted to identify the defects and to highlight and characterize the contours and shape of the defects in an improved manner;
apply Computer Vision techniques/algorithms to said second processed image to determine characterizing information of each of the detected defects, wherein said characterizing information comprise, for each of the identified defects, at least the following: defect category, position of the defect with respect to a reference coordinate system associated with the image, at least one geometric/dimensional parameter of each defect.

49. A system according to claim 48, wherein the electronic processing means are configured to provide a user/operator with a graphical interface, configured to allow the user/operator to perform one or more of the following actions:
selecting the micrograph or digital image, or micrographs or digital images, to be processed and analyzed, among the acquired micrographs or digital images of the object sample; and/or
displaying, on each selected micrograph or digital image, the masks processed by the trained algorithm and/or the first processed digital images and/or the second processed digital images; and/or
displaying, for each identified defect, the category of the defect, and/or the position of the defect with respect to a reference coordinate system associated with the digital image, and/or said at least one geometric/dimensional parameter of the defect; and/or
manually defining, in the digital image, a region around the defect considered if the result is unsatisfactory, and re-launching the execution of the method steps.

50. A system according to claim 48, wherein said micrograph or digital image acquisition means comprises an electron microscope,
and/or wherein said electronic processing means comprise a local electronic processor, or edge device, operatively connected to the acquisition means,
and/or wherein said electronic processing means comprise a user device, a remote server and a remote computer, connected to one another in the cloud, and operatively connected through the web to the digital image acquisition means and the user device capable of providing a graphical interface.
